(19) United States
(12) Patent Application Publication
(10) Pub. No.: US 2017/0178275 A1
(43) Pub. Date: Jun. 22, 2017

(54) METHOD AND SYSTEM FOR USING SOLID STATE DEVICE AS EVICTION PAD FOR GRAPHICS PROCESSING UNIT

(71) Applicant: Advanced Micro Devices, Inc., Sunnyvale, CA (US)

(72) Inventors: Tzachi Cohen, Ramat Gan (IL); Yaki Tebeka, Ramat Gan (IL); Assaf Pagi, Ramat Gan (IL)

(73) Assignee: Advanced Micro Devices, Inc., Sunnyvale, CA (US)

(21) Appl. No.: 14/978,066

(22) Filed: Dec. 22, 2015

(51) Int. Cl. G06T 1/20; G06F 3/06; G06F 13/28; G06T 1/60

(52) U.S. Cl. CPC G06T 1/20; G06T 1/60; G06F 3/0608; G06F 3/0631; G06F 3/0652; G06F 3/0688; G06F 13/28

(57) ABSTRACT

Described is a method and system for using a solid state device (SSD) as an eviction pad for graphics processing units (GPUs). The method for eviction processing includes a processor that determines when a dedicated memory associated with a GPU and a host memory associated with the processor are congested. The processor sends a content transfer command to the SSD. The SSD initiates a content transfer directly with the dedicated memory associated with the GPU. The GPU transfers the contents directly to the SSD. The processor sends a content transfer command to the SSD when the evicted contents are needed by the GPU. The SSD then initiates and transfers the evicted contents back to the dedicated memory.

### TECHNICAL FIELD

The disclosed embodiments are generally directed to memory processing, and in particular, to memory congestion handling for graphics processing units.

### BACKGROUND

A graphics processing unit (GPU) may be nominally configured with a certain amount of dedicated or local memory, (hereinafter referred to as dedicated), to service operations performed on the GPU. For example, the dedicated memory may be dynamic random access memory. However, certain applications may require more dedicated memory, (e.g. in the form of application buffers), than available. In this scenario, an operating system (OS), display driver, device driver or similar hardware/software entity of a host computing system may decide to evict content from buffers, such as application buffers for example, that are not currently in use to a host memory associated with the host computing system. In other words, the OS may manage the residency of the buffers, including the application buffers, in the dedicated memory based on which buffer is being addressed by a currently executing command buffer. When the host memory is equally congested or pressured, (i.e. in addition to GPU dedicated memory contention or congestion), the OS may swap the content of the buffers to a storage drive associated with the host computing system and use a page fault mechanism to fetch the content of the buffers back to host memory when needed. The above process entails a two hop eviction process; first from the dedicated memory to the host memory, and then from the host memory to the storage drive.

Eviction from GPU dedicated memory to host memory is made with buffer granularity, where buffer size is determined according to application requirements and may be hundreds of megabytes in size. Host memory to storage drive eviction is nominally done using pages, where a page may be 4 Kbytes in size. The OS may evict these pages based on usage heuristics with per page granularity which may be too fine for graphic resources as the OS may determine that an entire resource, substantially bigger than 4 Kbytes, may not be required in the near future. All of these factors may lead to overall system performance degradation. Evicting large buffers from GPU dedicated memory directly to a storage drive may save the CPU processing overhead required to evict the buffer from host memory to a storage drive in small chunks, with page granularity, had it been evicted to host memory first. In addition, the transfer of content to or from the dedicated memory may be prevalently done through the GPU's direct memory DMA engine.

### SUMMARY OF EMBODIMENTS

Described is a method and system for using a solid state device (SSD) as an eviction pad for graphics processing units (GPUs). The method for eviction processing includes a processor that determines when a dedicated memory associated with a GPU and a host memory associated with the processor are congested. The processor sends a content transfer command to the SSD. The SSD initiates a content transfer directly with the dedicated memory associated with the GPU. The GPU transfers the contents directly to the SSD. The processor sends a content transfer command to the SSD when the evicted contents are needed by the GPU. The SSD then initiates the transfer and transfers the evicted contents back to the dedicated memory.

### BRIEF DESCRIPTION OF THE DRAWINGS

A more detailed understanding may be had from the following description, given by way of example in conjunction with the accompanying drawings wherein:

FIG. 1 is a processing system with a central processing unit and a graphics processing unit in accordance with certain embodiments;

FIG. 2 is a solid state device in accordance with certain embodiments;

FIG. 3 is an eviction flow diagram using the processing system of FIG. 1;

FIG. 4 is an eviction flow diagram using the processing system of FIG. 1 in accordance with certain embodiments;

FIG. 5 is a flowchart for an eviction process in accordance with certain embodiments; and

FIG. 6 is a block diagram of an example device in which one or more disclosed embodiments may be implemented.

### DETAILED DESCRIPTION OF THE EMBODIMENTS

In general, a method and system is described where a solid state device may be used as an eviction pad for a graphics processing unit (GPU). In particular, an operating system (OS), display drive, device driver or like hardware/software component (hereinafter referred to as OS for purposes of illustration) may determine that a dedicated memory associated with the GPU and a host memory are congested or unavailable for running an operation. The OS may then instruct or enable direct transfer of certain contents from the dedicated memory to a solid state device (SSD). This direct transfer may be initiated by a direct memory access (DMA) controller on the SSD. The OS may also instruct the SSD to transfer the evicted contents back to the dedicated memory when needed by the GPU. This direct transfer may also be initiated by the direct memory access (DMA) controller on the SSD. This peer-to-peer content transfer may alleviate the disadvantages discussed herein.

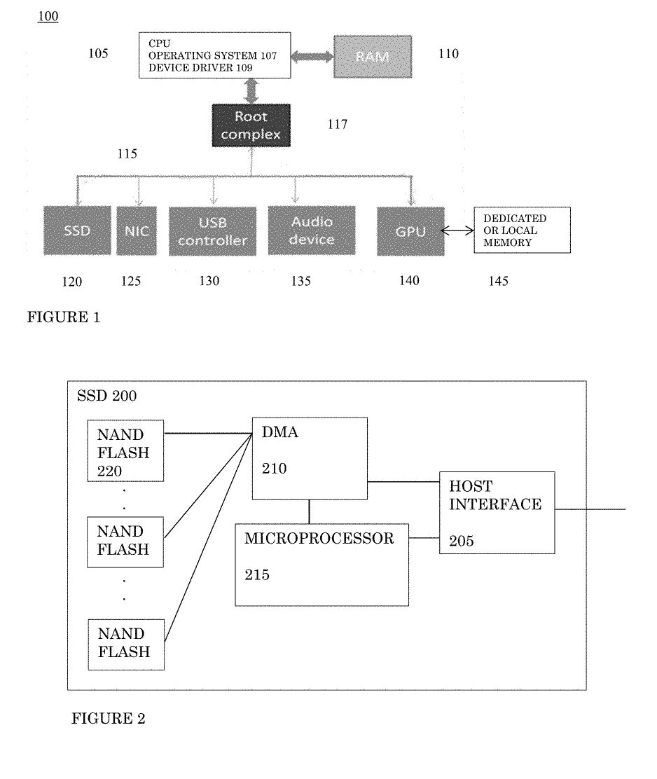

FIG. 1 shows an example processing system 100 in accordance with certain embodiments. The processing system 100 may include a host computer, such as for example a central processing unit (CPU) 105, which may be connected to or in communication with a host memory such as for example random access memory (RAM) 110. The CPU 105 may include an operating system (OS) 107, a device driver 109 and other nominal elements. The CPU 105 may also be connected to or in communication with a number of components, including but not limited to, an SSD 120, a network interface card (NIC) 125, a Universal Serial Bus (USB) controller 130, an audio device 135 and a GPU 140 which may have a dedicated or local (hereinafter “dedicated”) memory 145. The dedicated memory 145 may also be referred to as system visible memory. For purposes of illustration only, the dedicated memory 145 may be 1-32 Gbytes. The components shown are illustrative and other components may also be connected to or be in communication with the CPU 105. The components may be connected to or be in communication with the CPU 105 using, for example, a high-speed serial computer expansion bus, such as but not limited to, a Peripheral Component Interconnect Express (PCI-e) 115. Each bus of the PCI-e 115 may end at a top level node, which may be referred to as a root complex 117. The PCI-e 115 is shown for purposes of illustration and other electrical or communication interfaces may be used.

FIG. 2 is an example SSD 200 in accordance with certain embodiments. The SSD 200 may include a host interface 205 for interfacing with a host computer (not shown). The host interface 205 may also be connected to or in communication with a direct memory access (DMA) controller 210 and a microprocessor 215. The microprocessor 215 may operationally manage the SSD 200 and in particular, may decode incoming commands from the host computer. The DMA controller 210 may control data movement between the host interface 205 and a set of NAND flash 220.

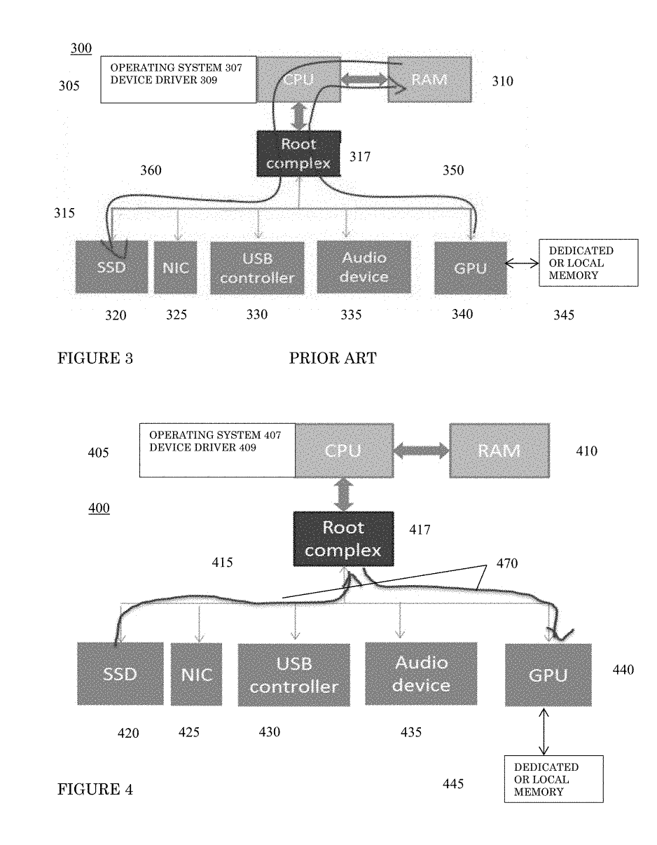

FIG. 3 is an example eviction flow diagram using the processing system of FIG. 1. As described herein, a processing system 300 may include a CPU 305, which may be connected to or in communication with a host memory such as RAM 310. The CPU 105 may include an OS 307, a device driver 309 and other nominal elements. The CPU 305 may also be connected to or in communication with a number of components, including but not limited to, a SSD 320, a NIC 325, a USB controller 330, an audio device 335 and a GPU 340 which may have a dedicated memory 345. The components shown are illustrative and other components may also be connected to or be in communication with the CPU 305. The components may be connected to or be in communication with the CPU 305 using, for example, a high-speed serial computer expansion bus, such as but not limited to, a PCI-e 315, which may have a top level node, i.e. a root complex 317.

When the GPU 340 is executing certain commands, the OS 307 or device driver 309 may determine that the dedicated memory 345 does not have sufficient memory to store data, application or operational content, (hereinafter “content”) required for execution of the command. The OS 307/device driver 309 may evict content associated with a desired amount of memory from the dedicated memory 345 to the RAM 310 (350). When the RAM 310 is equally congested, the OS 307/device driver 309 may in turn evict certain content from the RAM 310 to the SSD 320 (360). As shown in FIG. 3, this process entails a two hop eviction process, from the dedicated memory 345 to the RAM 310 and from the RAM 310 to the SSD 320. Moreover, content transfer from the dedicated memory 345 may be mostly done using a DMA in the GPU 340. This may expend unnecessary resources, increase latency and decrease system performance.

Described herein is a method and system for evicting content directly from a GPU dedicated memory to a SSD. FIG. 4 is an example eviction flow diagram in accordance with certain embodiments. FIG. 4 illustrates a processing system 400 which may include a CPU 405 having at least an OS 407, a device driver 409 and other nominal elements. The CPU 405 may be connected to or in communication with a host memory such as for example RAM 410. The CPU 405 may also be connected to or in communication with a number of components, including but not limited to, a SSD 420, a NIC 425, a USB controller 430, an audio device 435 and a GPU 440 which may have a dedicated memory 445. The components shown are illustrative and other components may also be connected to or be in communication with the CPU 405. The components may be connected to or be in communication with the CPU 405 using, for example, a high-speed serial computer expansion bus, such as but not limited to, a PCI-e 415, which may have a top level node, i.e. a root complex 417.

When the GPU 440 is executing certain commands, the OS 407 or device driver 409 may determine that the dedicated memory 445 does not have sufficient memory to store content required for execution of the command. The OS 407/device driver 409 may attempt to evict an equivalent amount of content from the dedicated memory 445 to the RAM 410. However, the OS 407/device driver 409 may also determine that RAM 410 is equally congested. In this event, the OS 407/device driver 409 may send an instruction to the SSD 420 to initiate content transfer from the dedicated memory 445. The SSD 420 may then initiate and execute the content transfer directly with the dedicated memory 445 (470). As shown in FIG. 4, this process uses a single hop eviction process, from the dedicated memory 445 to the SSD 420. Moreover, content transfer from the dedicated memory 445 is initiated by a DMA 210 in the SSD 420, (as shown in FIG. 2). This may increase the efficiency of the CPU 405 as it is not involved in the actual transfer of the content, increase the efficiency of the GPU 440 as it is not using resources, such as for example at least DMA resources, for initiating and executing for the transfer, decrease system latency and increase system performance.

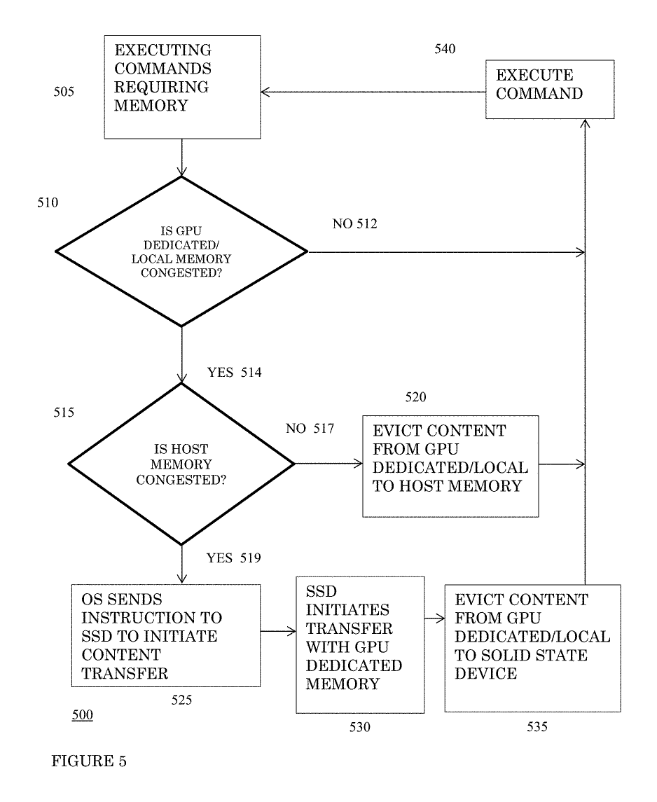

FIG. 5, in concert with FIG. 4, shows an example flowchart 500 for evicting content directly from the dedicated memory 445 of GPU 440 to a SSD 420. As commands are sent to the GPU 440 (505), the OS 407/device driver 409 may determine if the dedicated memory 445 is congested (510). When the dedicated memory 445 is not congested (512), execution of the command may proceed (540).

When the dedicated memory 445 is congested (514), the OS 407/device driver 409 may determine if the RAM 410 is congested (515). When the RAM 410 is not congested (517), then content may be evicted to the RAM 410 (520), followed by execution of the command (540).

When the RAM 410 is congested (519), then the OS 407/device driver 409 may allocate memory on the SSD 420 and send an instruction or command to the SSD 420 to initiate content transfer (525). The DMA in the SSD 420 may then initiate the content transfer from the dedicated memory 445 (530). The contents may be evicted to the SSD 420 (535), followed by execution of the command (540). When the evicted contents stored in the SSD 420 are needed for execution of a command, the GPU 440 may allocate space in the dedicated memory 445 and the OS 407/device driver 409 may send a content transfer request to the SSD 420 to return the evicted contents directly back to the dedicated memory 445. The SSD 420 then uses its DMA to initiate and directly transfer the contents back to the dedicated memory 445.

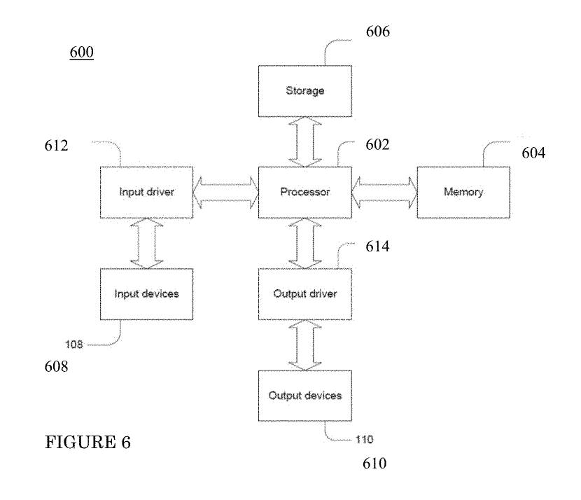

FIG. 6 is a block diagram of an example device 600 in which one portion of one or more disclosed embodiments may be implemented. The device 600 may include, for example, a head mounted device, a server, a computer, a gaming device, a handheld device, a set-top box, a television, a mobile phone, or a tablet computer. The device 600 includes a processor 602, a memory 604, a storage 606, one or more input devices 608, and one or more output devices 610. The device 600 may also optionally include an input driver 612 and an output driver 614. It is understood that the device 600 may include additional components not shown in FIG. 6.

The processor 602 may include a central processing unit (CPU), a graphics processing unit (GPU), a CPU and GPU located on the same die, or one or more processor cores, wherein each processor core may be a CPU or a GPU. The memory 604 may be located on the same die as the processor 602, or may be located separately from the processor 602. The memory 604 may include a volatile or non-volatile memory, for example, random access memory (RAM), dynamic RAM, or a cache.

The storage 606 may include a fixed or removable storage, for example, a hard disk drive, a solid state drive, an optical disk, or a flash drive. The input devices 608 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 610 may include a display, a speaker, a printer, a haptic feedback device, one or more lights, an antenna, or a network connection (e.g., a wireless local area network card for transmission and/or reception of wireless IEEE 802 signals).

The input driver 612 communicates with the processor 602 and the input devices 608, and permits the processor 602 to receive input from the input devices 608. The output driver 614 communicates with the processor 602 and the output devices 610, and permits the processor 602 to send output to the output devices 610. It is noted that the input driver 612 and the output driver 614 are optional components, and that the device 600 will operate in the same manner if the input driver 612 and the output driver 614 are not present.

In general and without limiting embodiments described herein, a computer readable non-transitory medium including instructions which when executed in a processing system cause the processing system to execute a method for evicting resources directly from a dedicated memory in a GPU to a SSD.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for eviction processing, the method comprising:
receiving, at a controller associated with a solid state device, a content transfer command from a processor when a dedicated memory associated with a graphics processing unit (GPU) and a host memory associated with the processor are congested, wherein the processor is in communication with the GPU;
initiating, by the controller, a content transfer directly from the dedicated memory; and
receiving, at the solid state device, contents evicted from the dedicated memory.

2. The method of claim 1, further comprising:
allocating memory in the solid state device to store the contents from the dedicated memory.

3. The method of claim 1, further comprising:
transferring evicted contents to the dedicated memory in response to a content transfer request from the processor.

4. The method of claim 1, wherein the controller is a direct memory access controller.

5. The method of claim 1, further comprising:
receiving, at the controller associated with the solid state device, a content transfer command from the processor when evicted contents are needed by the GPU;
initiating, by the controller, a content transfer directly to the dedicated memory; and
sending, from the solid state device, the evicted contents to the dedicated memory.

6. An apparatus for eviction processing, comprising:
a solid state device including a controller and a persistent memory;
the controller configured to receive a content transfer command from a processor when a dedicated memory associated with a graphics processing unit (GPU) and a host memory associated with the processor are congested, wherein the processor is in communication with the GPU;
the controller configured to directly initiate a content transfer from the dedicated memory; and
the persistent memory configured to store contents evicted from the dedicated memory.

7. The apparatus of claim 6, further comprising:
the solid state device configured to allocate space in the memory to store the contents from the dedicated memory.

8. The apparatus of claim 6, further comprising:
an interface configured to receive the contents from the dedicated memory for storing in the memory.

9. The apparatus of claim 6, wherein the controller is a direct memory access controller.

10. The apparatus of claim 6, further comprising:
the controller configured to send evicted contents to the GPU in response to a content transfer request from the processor.

11. The apparatus of claim 6, further comprising:
the controller configured to receive a content transfer command from the processor when evicted contents are needed by the GPU;
initiating, by the controller, a content transfer directly to the dedicated memory; and
sending, from the solid state device, the evicted contents to the dedicated memory.

12. An apparatus for eviction processing, comprising:
a graphics processing unit (GPU) with a dedicated memory;
the GPU configured to directly receive a content transfer request from a solid state device when a central processing unit (CPU) determines that the dedicated memory and host memory are congested; and
the GPU configured to send contents to the solid state device responsive to the content transfer request.

13. The apparatus of claim 12, further comprising:
the GPU configured to directly receive evicted contents from the solid state device in response to a content transfer request from the CPU.

14. A computer readable non-transitory medium including instructions which when executed in a processing system cause the processing system to execute a method for eviction processing, the method comprising the steps of:
receiving, at a controller associated with a solid state device, a content transfer command from a processor when a dedicated memory associated with a graphics processing unit (GPU) and a host memory associated with the processor are congested, wherein the processor is in communication with the GPU;
initiating, by the controller, a content transfer directly from the dedicated memory; and
receiving, at the solid state device, contents evicted from the dedicated memory.

15. The computer readable non-transitory medium of claim 14, further comprising:
allocating memory in the solid state device to store the contents from the dedicated memory.

16. The computer readable non-transitory medium of claim 14, further comprising:
transferring evicted contents to the dedicated memory in response to a content transfer request from the processor.

17. The computer readable non-transitory medium of claim 14, wherein the controller is a direct memory access controller.

18. The computer readable non-transitory medium of claim 14, further comprising:
receiving, at the controller associated with the solid state device, a content transfer command from the processor when evicted contents are needed by the GPU;
initiating, by the controller, a content transfer directly to the dedicated memory; and
sending, from the solid state device, the evicted contents to the dedicated memory.
